(19) United States
(12) Patent Application Publication
(10) Pub. No.: US 2022/0063657 A1
(43) Pub. Date: Mar. 3, 2022

(54) TRAVEL CONTROLLER AND METHOD FOR TRAVEL CONTROL

(71) Applicant: TOYOTA JIDOSHA KABUSHIKI KAISHA, Toyota-shi (JP)

(72) Inventors: Takao KASHU, Tokyo-to (JP); Yasutaka TERAMAE, Kawasaki-shi (JP); Hirotaka KATO, Nukata-gun (JP); Ryo MASUTANI, Tokyo-to (JP); Ichi GI, Tokyo-to (JP)

(73) Assignee: TOYOTA JIDOSHA KABUSHIKI KAISHA, Toyota-shi (JP)

(21) Appl. No.: 17/461,236

(22) Filed: Aug. 30, 2021

(30) Foreign Application Priority Data
Aug. 31, 2020 (JP) 2020-145830

(51) Int. Cl. B60W 60/00; G06K 9/00

(52) U.S. Cl. CPC B60W 60/001; G06K 9/00798; B60W 2554/4049; B60W 2420/42; B60W 2554/4045; B60W 2552/53

(57) ABSTRACT

A travel controller identifies a current lane on which a vehicle is traveling in a first lane zone traveled by the vehicle and including lanes, and detects a non-lane zone within a predetermined distance ahead of a current position of the vehicle. The non-lane zone lacks lanes and lies between the first lane zone and a second lane zone including fewer lanes than the first lane zone. Of the lanes included in the second lane zone, the travel controller identifies a lane having a start point whose distance from an end point of the current lane is the shortest, and preferentially selects, as a route in the non-lane zone, a route connecting the end point of the current lane and the start point of the lane identified in the second lane zone.

### FIELD

The present disclosure relates to a travel controller and a method for automatically controlling travel of a vehicle.

### BACKGROUND

A travel controller is known that automatically controls travel of a vehicle, based on a surrounding image generated by a camera mounted on the vehicle. The travel controller detects lane lines from the surrounding image, and controls travel of the vehicle so that it will travel along a lane defined by the lane lines.

Japanese Unexamined Patent Publication No. 2016-222170 (hereafter, “Patent Literature 1”) describes a drive assist apparatus that assists in driving even in a zone where no lane line is detected (non-lane zone). In a non-lane zone, e.g., a zone before and after a tollgate of an expressway, the drive assist apparatus described in Patent Literature 1 controls a vehicle so that it will travel along a scheduled traveling route leading from the position of the vehicle via the position of the tollgate to a position of a target lane.

### SUMMARY

When a target lane to be traveled after a non-lane zone is selected in accordance with a predetermined principle, e.g., a principle that the leftmost lane should be selected, a travel controller may control travel along a route unexpected for a driver.

It is an object of the present disclosure to provide a travel controller that can select a route agreeable to a driver in a non-lane zone.

A travel controller according to the present disclosure includes a processor configured to identify a current lane on which a vehicle is traveling in a first lane zone traveled by the vehicle and including lanes; detect a non-lane zone within a predetermined distance ahead of a current position of the vehicle, the non-lane zone lacking lanes and lying between the first lane zone and a second lane zone including fewer lanes than the first lane zone; of the lanes included in the second lane zone, identify a lane having a start point whose distance from an end point of the current lane is the shortest; and preferentially select, as a route in the non-lane zone, a route connecting the end point of the current lane and the start point of the lane identified in the second lane zone.

The processor of the travel controller according to the present disclosure preferably selects, when another vehicle is traveling on one of two lanes adjoining the current lane in the first lane zone and no vehicle is traveling on the other of the two lanes, a route connecting the end point of the current lane and a lane that adjoins the lane identified in the second lane zone and that does not merge with the lane on which another vehicle is traveling in the first lane zone, instead of the route connecting the end point of the current lane and the start point of the lane identified in the second lane zone, the one of two lanes merging with the lane identified in the second lane zone.

The processor of the travel controller according to the present disclosure is preferably further configured to notify a driver of the vehicle of a request from detection of the non-lane zone until the vehicle reaches the non-lane zone, the request asking the driver to hold a steering wheel.

The processor of the travel controller according to the present disclosure is preferably further configured to reduce reactive force against turning the steering wheel during travel in the non-lane zone lower than reactive force during travel in a zone other than the non-lane zone.

A method for travel control according to the present disclosure includes identifying a current lane on which a vehicle is traveling in a first lane zone traveled by the vehicle and including lanes; detecting a non-lane zone within a predetermined distance ahead of a current position of the vehicle, the non-lane zone lacking lanes and lying between the first lane zone and a second lane zone including fewer lanes than the first lane zone; of the lanes included in the second lane zone, identifying a lane having a start point whose distance from an end point of the current lane is the shortest; and preferentially selecting, as a route in the non-lane zone, a route connecting the end point of the current lane and the start point of the lane identified in the second lane zone.

The travel controller according to the present disclosure can reduce lane changes unexpected for a driver before and after a non-lane zone.

### BRIEF DESCRIPTION OF DRAWINGS

FIG. 1 schematically illustrates the configuration of a vehicle including a travel controller.

FIG. 2 schematically illustrates the hardware of the travel controller.

FIG. 3 is a functional block diagram of a processor included in the travel controller.

FIG. 4 is a diagram for describing a first example of travel control.

FIG. 5 is a diagram for describing a second example of travel control.

FIG. 6 is a flowchart of a travel control process.

### DESCRIPTION OF EMBODIMENTS

Hereinafter, a travel controller that can reduce lane changes unexpected for a driver before and after a non-lane zone will be explained in detail with reference to the accompanying drawings. The travel controller identifies a current lane on which a vehicle is traveling in a first lane zone traveled by the vehicle and including lanes. Within a predetermined distance ahead of a current position of the vehicle, the travel controller detects a non-lane zone lacking lanes and lying between the first lane zone and a second lane zone including fewer lanes than the first lane zone. Of the lanes included in the second lane zone, the travel controller further identifies a lane having a start point whose distance from an end point of the current lane is the shortest. The travel controller then preferentially selects, as a route in the non-lane zone, a route connecting the end point of the current lane and the start point of the lane identified in the second lane zone.

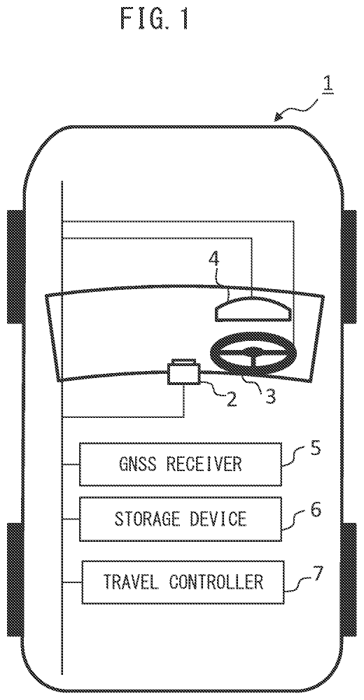

FIG. 1 schematically illustrates the configuration of a vehicle including a travel controller.

The vehicle 1 includes a camera 2, a steering wheel 3, a meter display 4, a global navigation satellite system (GNSS) receiver 5, a storage device 6, and a travel controller 7. The camera 2, the steering wheel 3, the meter display 4, the GNSS receiver 5, and the storage device 6 are connected to the travel controller 7 via an in-vehicle network conforming to a standard, such as a controller area network, so that they can communicate with each other.

The camera 2 is an example of a sensor for detecting surroundings of the vehicle. The camera 2 includes a two-dimensional detector constructed from an array of optoelectronic transducers, such as CCD or C-MOS, having sensitivity to visible light and a focusing optical system focusing an image of a target region on the two-dimensional detector. The camera 2 is disposed, for example, in a front and upper area in the interior of the vehicle and oriented forward, takes a picture of the surroundings of the vehicle 1 through a windshield every predetermined capturing period (e.g., 1/30 to 1/10 seconds), and outputs images corresponding to the surroundings.

The steering wheel 3 is an example of an operation unit, and is operated by a driver who makes a steering mechanism for steering the vehicle 1 operate. The operation to make the steering mechanism operate is, for example, turning the steering wheel 3 clockwise or counterclockwise. As other operation units, the vehicle 1 includes an accelerator pedal and a brake pedal (not shown).

The meter display 4 is an example of a display, and includes, for example, a liquid crystal display. The meter display 4 displays information on travel of the vehicle 1 so as to be visible to the driver, according to a signal received from the travel controller 7 via the in-vehicle network.

The GNSS receiver 5 receives a GNSS signal from a GNSS satellite at predetermined intervals, and determines the position of the vehicle 1, based on the received GNSS signal. The GNSS receiver 5 outputs a positioning signal indicating the result of determination of the position of the vehicle 1 based on the GNSS signal to the travel controller 7 via the in-vehicle network at predetermined intervals.

The storage device 6 is an example of a storage unit, and includes, for example, a hard disk drive or a nonvolatile semiconductor memory. The storage device 6 stores a high-precision map, which includes, for example, information indicating lane lines on roads included in a predetermined region shown on this map.

The travel controller 7 is an electronic control unit (ECU) including a communication interface, a memory, and a processor. The travel controller 7 detects a non-lane zone ahead of the vehicle 1, based on an image received from the camera 2 via the communication interface, and controls travel of the vehicle in the non-lane zone.

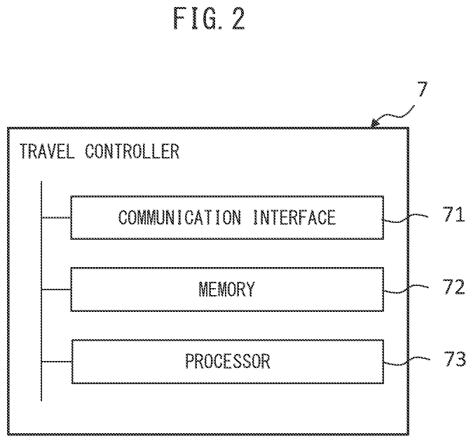

FIG. 2 schematically illustrates the hardware of the travel controller 7. The travel controller 7 includes a communication interface 71, a memory 72, and a processor 73.

The communication interface 71 is an example of a communication unit, and includes a communication interface circuit for connecting the travel controller 7 to the in-vehicle network. The communication interface 71 provides received data for the processor 73, and outputs data provided from the processor 73 to an external device.

The memory 72 is an example of a storage unit, and includes volatile and nonvolatile semiconductor memories. The memory 72 stores various types of data used for processing by the processor 73, such as a distance threshold for determining the distance range ahead of a current position in which a non-lane zone may be detected, and travel-lane side information indicating on which side of each road a travel lane lies. The memory 72 also stores various application programs, such as a travel control program for executing a travel control process.

The processor 73 is an example of a control unit, and includes one or more processors and a peripheral circuit thereof. The processor 73 may further include another operating circuit, such as a logic-arithmetic unit, an arithmetic unit, or a graphics processing unit.

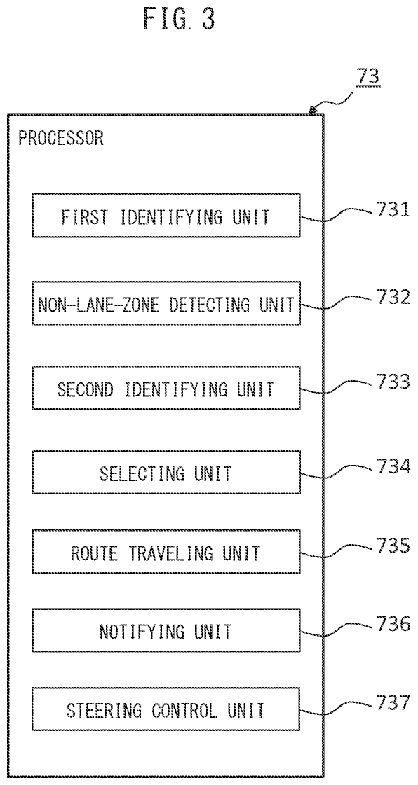

FIG. 3 is a functional block diagram of the processor 73 included in the travel controller 7.

As its functional blocks, the processor 73 of the travel controller 7 includes a first identifying unit 731, a non-lane-zone detecting unit 732, a second identifying unit 733, a selecting unit 734, a route traveling unit 735, a notifying unit 736, and a steering control unit 737. These units included in the processor 73 are functional modules implemented by a program executed on the processor 73, or may be implemented in the travel controller 7 as separate integrated circuits, microprocessors, or firmware.

The first identifying unit 731 inputs an image received from the camera 2 via the communication interface into a classifier that has been trained to detect lane lines, thereby identifying the current lane on which the vehicle 1 is traveling, of the lanes included in a first lane zone where the vehicle 1 is traveling. Lane lines are demarcation lines drawn on a road for dividing lanes.

The classifier may be, for example, a convolution neural network (CNN) including multiple convolutional layers connected in series from the input toward the output. A CNN that has been trained using inputted images including lane lines as training data operates as a classifier to detect lane lines.

For example, when one lane line is detected on the left of the vehicle 1 and two lane lines on the right from an image of surroundings of the first lane zone received from the camera 2, the first identifying unit 731 identifies the left one of the two lanes included in the first lane zone as the current lane.

The non-lane-zone detecting unit 732 detects a non-lane zone within a predetermined distance ahead of the current position of the vehicle, based on lane lines detected from the received image. The non-lane zone lacks lanes and lies between the first lane zone and a second lane zone including fewer lanes than the first lane zone. When three or more lane lines arrayed in the horizontal direction of the image are detected, the non-lane-zone detecting unit 732 determines that the road defined by the leftmost and rightmost lane lines is divided into multiple lanes by the intervening lane lines. For example, assume that a lane zone divided into multiple lanes, a zone where only two lane lines are detected, and another lane zone are sequentially detected from the bottom to the top of the received image. In this case, the non-lane-zone detecting unit 732 determines that the zone where only two lane lines are detected is a non-lane zone lying between the first lane zone on the bottom side of the image and the second lane zone on the top side.

The non-lane-zone detecting unit 732 may detect a non-lane zone, based on a high-precision map stored in the storage device 6. For example, the non-lane-zone detecting unit 732 receives a positioning signal from the GNSS receiver 5, and obtains a high-precision map of the location corresponding to the positioning signal from the storage device 6. The non-lane-zone detecting unit 732 then detects a non-lane zone, based on information on lane lines in the high-precision map.

The second identifying unit 733 identifies, of the lanes included in the second lane zone, a lane having a start point whose distance from the end point of the current lane is the shortest. The end point or the start point of a lane is a midpoint of ends of lane lines forming a pair defining the lane.

The selecting unit 734 preferentially selects, as a route in the non-lane zone, a route connecting the end point of the current lane and the start point of the lane identified in the second lane zone.

The route traveling unit 735 outputs a control signal to a travel mechanism (not shown) of the vehicle 1 via an input/output interface so as to travel along the route selected by the selecting unit 734. The travel mechanism includes, for example, an engine for supplying motive power to the vehicle 1, a brake for decreasing the travel speed of the vehicle 1, and the steering mechanism for steering the vehicle 1.

The notifying unit 736 transmits a display signal to display information for notifying, from detection of a non-lane zone until the vehicle 1 reaches the non-lane zone, the driver of the vehicle 1 of a request to hold the steering wheel 3 to the meter display 4 via the communication interface 71. The information for notifying the driver of the vehicle 1 of a request to hold the steering wheel 3 is, for example, a message such as “Hold the steering wheel,” and an image showing the state in which the steering wheel is held. The notifying unit 736 may transmit a voice signal to play back a voice to make a notification of a request to hold the steering wheel to a vehicle-mounted speaker (not shown) via the communication interface 71.

The steering control unit 737 sets reactive force against turning the steering wheel 3 by the driver of the vehicle 1. The steering control unit 737 transmits via the communication interface 71 a reactive-force setting signal for setting the reactive force to a steering controller (not shown) that controls an actuator (not shown) provided for the steering wheel 3. The steering control unit 737 transmits the reactive-force setting signal to the steering controller so as to reduce the reactive force during travel in a non-lane zone lower than the reactive force during travel in a zone other than a non-lane zone.

Control by the steering control unit 737 to reduce reactive force of the steering wheel 3 during travel in a non-lane zone enables the driver to turn the steering wheel 3 with smaller force.

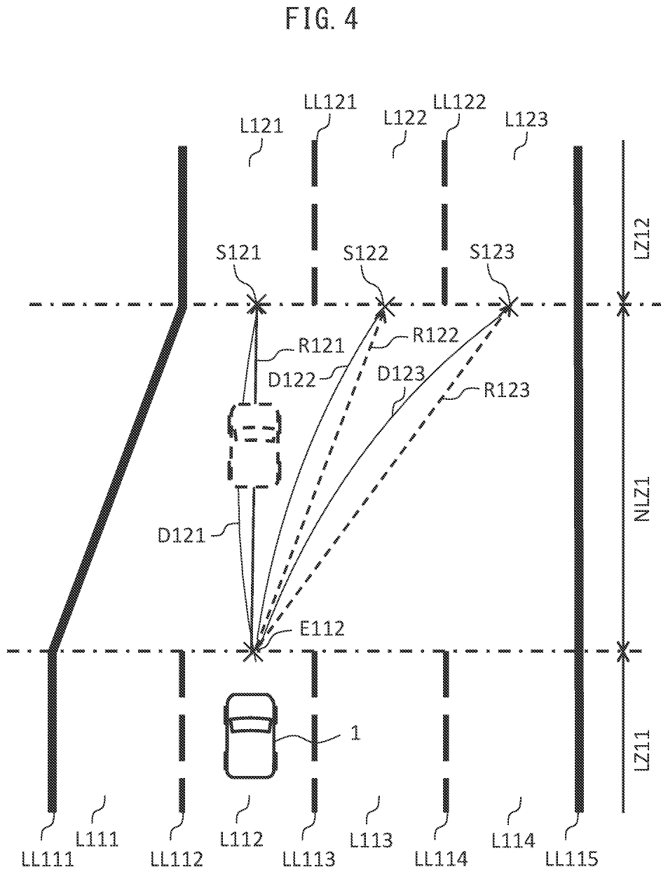

FIG. 4 illustrates a first example of travel control.

The vehicle 1 is traveling from the bottom to the top of the figure. At this time, the first identifying unit 731 of the vehicle 1 detects, from an image captured by the camera 2, five lane lines LL111-LL115 arrayed in the horizontal direction of the image. Since more than three lane lines arrayed in the horizontal direction of the image are detected, the zone of the road through which the vehicle 1 is traveling is a first lane zone LZ11 divided into multiple lanes. The first identifying unit 731 identifies the second lane L112 from the left in the first lane zone LZ11 as the current lane.

The non-lane-zone detecting unit 732 detects a non-lane zone NLZ1 where only the two lane lines LL111 and LL115 arrayed in the horizontal direction of the image are detected, ahead of the current position of the vehicle 1. The non-lane-zone detecting unit 732 also detects a lane zone where four lane lines LL111, LL121, LL122, and LL115 arrayed in the horizontal direction of the image are detected, further ahead of the non-lane zone NLZ1. The lane zone, which includes lanes L121-L123, is a second lane zone LZ12 including lanes the number of which is different from that of lanes included in the first lane zone LZ11. In the example of FIG. 4, the number of lanes included in the second lane zone LZ12 is three, which is less than that of lanes, four, included in the first lane zone LZ11.

Of the lanes L121-L123 included in the second lane zone LZ12, the second identifying unit 733 identifies a lane having a start point whose distance from an end point E112 of the current lane L112 is the shortest. The distance D121 from the end point E112 of the lane L112 to a start point S121 of the lane L121 is shorter than the distance D122 from the end point E112 to a start point S122 of the lane L122 and the distance D123 from the end point E112 to a start point S123 of the lane L123. Hence the second identifying unit 733 identifies the lane L121 as the lane having a start point whose distance from the end point E112 of the current lane L112 is the shortest.

As a route in the non-lane zone NLZ1, the selecting unit 734 preferentially selects a route R121 connecting the end point E112 of the lane L112 and the start point S121 of the lane L121. The route traveling unit 735 then outputs a control signal to the travel mechanism (not shown) of the vehicle 1 via the input/output interface so that the vehicle 1 will travel along the route R121.

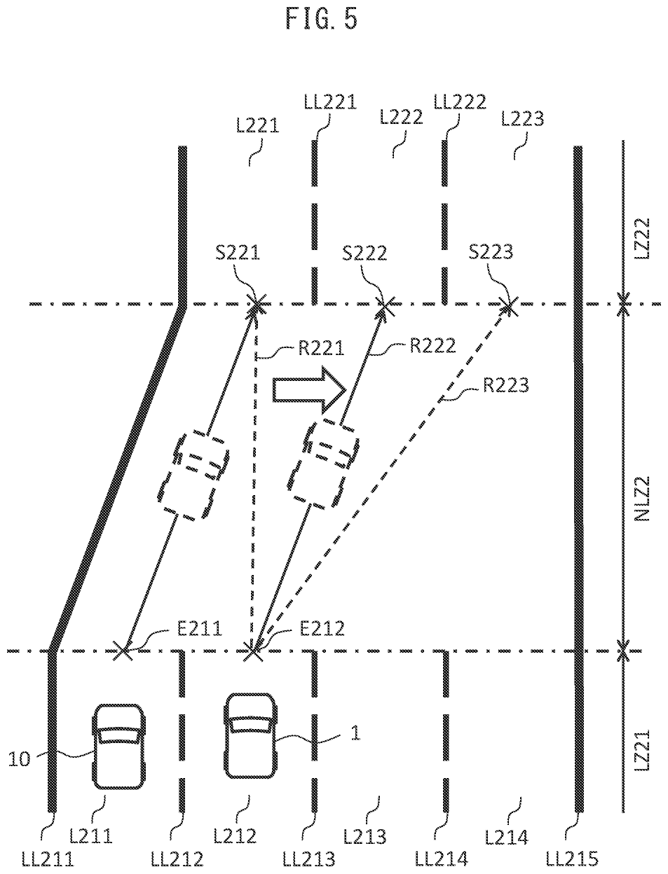

FIG. 5 illustrates a second example of travel control.

In the second example of travel control, the vehicle 1 is traveling on a lane L212 in a first lane zone LZ21 including lanes L211-L214, and another vehicle 10 is traveling on the lane L211 of the two lanes L211 and L213 adjoining the lane L212. However, no vehicle is traveling on the other lane L213 adjoining the lane L212 in the first lane zone LZ21. For example, the selecting unit 734 inputs an image received from the camera 2 into a classifier that has been trained to detect a vehicle, thereby detecting a vehicle traveling near the vehicle 1.

Of lanes L221-L223 included in a second lane zone LZ22, the lane L221 is identified as a lane having a start point whose distance from an end point E212 of the lane L212 on which the vehicle 1 is traveling is the shortest. However, of the lanes L221-L223 included in the second lane zone LZ22, the lane L221 is also the lane having a start point whose distance from an end point E211 of the lane L211 on which the other vehicle 10 is traveling is the shortest. In other words, the lane L211 on which the other vehicle 10 is traveling merges with the lane identified in the second lane zone LZ22. When the number of lanes of the second lane zone LZ22 is less than that of lanes of the first lane zone LZ21 as in this case, routes are set from multiple lanes in the first lane zone LZ21 to a lane in the second lane zone LZ22, resulting in traffic merging.

In the example illustrated in FIG. 5, the selecting unit 734 selects a route 8222 as a route in the non-lane zone, instead of a route 8221 connecting the end point E212 of the current lane and a start point S221 of the lane L221 identified in the second lane zone LZ22. The route R222 connects the end point E212 of the current lane and a start point S222 of the lane L222 that adjoins the lane L221 identified in the second lane zone LZ22 and that does not merge with the lane L211 on which the other vehicle is traveling. The route traveling unit 735 outputs a control signal to the travel mechanism (not shown) of the vehicle 1 via the input/output interface so that the vehicle 1 will travel along the route 8222.

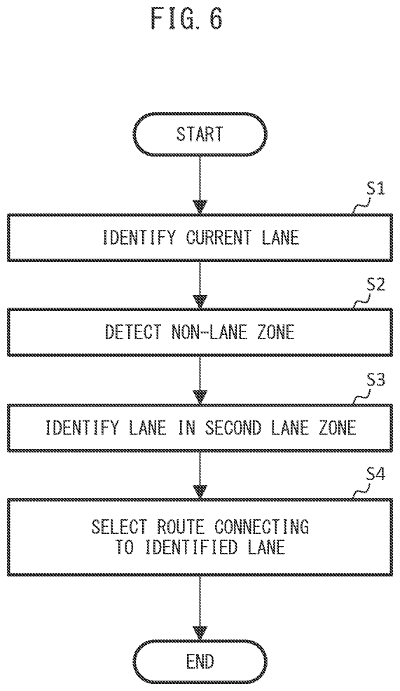

FIG. 6 is a flowchart of a travel control process. The travel controller 7 repeats this process at predetermined intervals (e.g., intervals of 1/10 seconds) during travel of the vehicle 1.

First, the first identifying unit 731 identifies a current lane on which the vehicle 1 is traveling in a first lane zone traveled by the vehicle 1 and including lanes (step S1).

Next, the non-lane-zone detecting unit 732 detects a non-lane zone lying between the first lane zone and a second lane zone, within a predetermined distance ahead of a current position (step S2).

Subsequently, of lanes included in the second lane zone, the second identifying unit 733 identifies a lane having a start point whose distance from an end point of the current lane is the shortest (step S3).

The selecting unit 734 preferentially selects, as a route in the non-lane zone, a route connecting the end point of the current lane and the start point of the lane identified in the second lane zone (step S4), and terminates the travel control process.

Executing the travel control process in this way, the travel controller 7 can reduce lane changes unexpected for a driver before and after a non-lane zone.

Note that those skilled in the art can apply various changes, substitutions, and modifications without departing from the spirit and scope of the present disclosure.

What is claimed is:

1. A travel controller comprising a processor configured to
identify a current lane on which a vehicle is traveling in a first lane zone traveled by the vehicle and including lanes;
detect a non-lane zone within a predetermined distance ahead of a current position of the vehicle, the non-lane zone lacking lanes and lying between the first lane zone and a second lane zone including fewer lanes than the first lane zone;
of the lanes included in the second lane zone, identify a lane having a start point whose distance from an end point of the current lane is the shortest; and
preferentially select, as a route in the non-lane zone, a route connecting the end point of the current lane and the start point of the lane identified in the second lane zone.

2. The travel controller according to claim 1, wherein the processor selects, when another vehicle is traveling on one of two lanes adjoining the current lane in the first lane zone and no vehicle is traveling on the other of the two lanes, a route connecting the end point of the current lane and a lane that adjoins the lane identified in the second lane zone and that does not merge with the lane on which another vehicle is traveling in the first lane zone, instead of the route connecting the end point of the current lane and the start point of the lane identified in the second lane zone, the one of two lanes merging with the lane identified in the second lane zone.

3. The travel controller according to claim 1, wherein the processor is further configured to notify a driver of the vehicle of a request from detection of the non-lane zone until the vehicle reaches the non-lane zone, the request asking the driver to hold a steering wheel.

4. The travel controller according to claim 3, wherein the processor is further configured to reduce reactive force against turning the steering wheel during travel in the non-lane zone lower than reactive force during travel in a zone other than the non-lane zone.

5. A method for travel control, comprising:
identifying a current lane on which a vehicle is traveling in a first lane zone traveled by the vehicle and including lanes;
detecting a non-lane zone within a predetermined distance ahead of a current position of the vehicle, the non-lane zone lacking lanes and lying between the first lane zone and a second lane zone including fewer lanes than the first lane zone;
of the lanes included in the second lane zone, identifying a lane having a start point whose distance from an end point of the current lane is the shortest; and
preferentially selecting, as a route in the non-lane zone, a route connecting the end point of the current lane and the start point of the lane identified in the second lane zone.
